(19) United States
(12) Patent Application Publication
(10) Pub. No.: US 2023/0116772 A1
(43) Pub. Date: Apr. 13, 2023

(54) IO PROCESSING METHOD FOR RAID SYSTEM, AND RELATED APPARATUS

(71) Applicant: INSPUR SUZHOU INTELLIGENT TECHNOLOGY CO., LTD., Suzhou, Jiangsu (CN)

(72) Inventor: Dan LIU, Suzhou, Jiangsu (CN)

(21) Appl. No.: 17/794,331

(22) PCT Filed: Jun. 28, 2020
(86) PCT No.: PCT/CN2020/098440

§ 371 Date: Jul. 21, 2022

(30) Foreign Application Priority Data
Jan. 21, 2020 (CN) 202010071075.4

(51) Int. Cl. G06F 3/06

(52) U.S. Cl. CPC G06F 3/0613; G06F 3/0689; G06F 3/0659

(57) ABSTRACT

Provided are an Input/Output (IO) processing method for a Redundant Array of Independent Disks (RAID) system, an IO processing apparatus for a RAID system, a storage server, and a computer-readable storage medium. The method includes: establishing, according to data volume region information, a stripe mapping relationship between a volume to be operated and a RAID stripe, and a controller correspondence relationship between the volume to be operated and a target controller; when receiving an IO processing request, determining a controller and RAID stripe corresponding to a target volume of the IO processing request according to the stripe mapping relationship and the controller correspondence relationship; and processing, by use of the RAID stripe through the controller, the IO processing request.

This application claims priority to Chinese Patent Application No. 202010071075.4, filed on Jan. 21, 2020, in China National Intellectual Property Administration and entitled “IO Processing Method for RAID System, and Related Apparatus”, the contents of which are hereby incorporated by reference in its entirety.

### FIELD

The present application relates to the technical field of storage systems, and particularly to an Input/Output (IO) processing method and IO processing apparatus for a Redundant Array of Independent Disks (RAID) system, a storage server, and a computer-readable storage medium.

### BACKGROUND

Currently, in the technical field of storage, RAID technology is usually used to improve the storage performance and reliability of a storage device. RAID is generally simply referred to as a disk array. Briefly, a RAID is a disk subsystem consisting of multiple independent high-performance disk drives that provide higher storage performance and data redundancy as compared to a single disk. RAID striping is a method of segmenting continuous data into data blocks of the same size and writing each segment of data to different disks in an array. Briefly, striping is a method of combining multiple disk drives into a volume. Therefore, to improve the performance of a storage device, the RAID is organized and managed by striping to ensure the consistency and reliability of data.

In the prior art, when data is written to a stripe, the stripe is locked first. In this way, an IO falling into the stripe in any manner may be processed only after the stripe is unlocked, thereby ensuring the correctness of data access. However, stripe locks cost resources. When an upper-layer system is under a heavy IO load, stripe locks need to wait for release due to excessive consumption, which further affects the IO processing speed. Therefore, stripe lock becomes one of bottlenecks for the storage performance index. Moreover, stripe locks particularly affect the performance in a multi-controller storage system. This is because stripe locks of multiple controllers need communication between the controllers for confirmation, which further affects the storage performance index.

Therefore, how to prevent stripe locks in a RAID from affecting the IO processing speed is a major concern of those skilled in the art.

### SUMMARY

An objective of the present application is to provide an IO processing method and IO processing apparatus for a RAID system, a storage server, and a computer-readable storage medium. A controller and RAID stripe for each IO processing are determined based on an established stripe mapping relationship and controller correspondence relationship, and thus are prevented from being called by other IOs. In this way, control may be implemented without a stripe lock, thereby avoiding performance loss and improving the processing speed.

In order to solve the foregoing technical problem, the present application provides an IO processing method for a RAID system, including:

establishing, according to data volume region information, a stripe mapping relationship between a volume to be operated and a RAID stripe, and a controller correspondence relationship between the volume to be operated and a target controller, wherein the stripe mapping relationship is a relationship where a RAID stripe uniquely corresponds to one volume to be operated;

when receiving an IO processing request, determining a controller and RAID stripe corresponding to a target volume of the IO processing request according to the stripe mapping relationship and the controller correspondence relationship; processing, by use of the RAID stripe through the controller, the IO processing request.

Optionally, the establishing, according to data volume region information, a stripe mapping relationship between a volume to be operated and a RAID stripe, and a controller correspondence relationship between the volume to be operated and a target controller includes:

determining, according to the data volume region information, an address range of the volume to be operated;

establishing the stripe mapping relationship between the address range of the volume to be operated and the RAID stripe;

establishing the controller correspondence relationship between the address range of the volume to be operated and the target controller.

Optionally, the when receiving an IO processing request, determining a controller and RAID stripe corresponding to a target volume of the IO processing request according to the stripe mapping relationship and the controller correspondence relationship includes:

when receiving the IO processing request, matching the target volume of the 10 processing request according to the stripe mapping relationship to obtain the RAID stripe;

matching the target volume of the IO processing request according to the controller correspondence relationship to obtain the controller.

Optionally, a capacity of the volume to be operated is in an integral multiple relationship with a size of the RAID stripe.

Optionally, the processing, by use of the RAID stripe through the controller, the IO processing request includes:

performing a splitting process on the IO processing request by use of the RAID stripe through the controller to obtain multiple IO processing sub-requests;

processing a storage device by use of the multiple IO processing sub-requests.

The present application also provides an IO processing apparatus for a RAID system, including:

a relationship establishing module, configured to establish, according to data volume region information, a stripe mapping relationship between a volume to be operated and a RAID stripe, and a controller correspondence relationship between the volume to be operated and a target controller, wherein the stripe mapping relationship is a relationship where a RAID stripe uniquely corresponds to one volume to be operated;

a relationship lookup module, configured to, when receiving an IO processing request, determine a controller and RAID stripe corresponding to a target volume of the IO processing request according to the stripe mapping relationship and the controller correspondence relationship;

an IO request processing module, configured to process, by use of the RAID stripe through the controller, the IO processing request.

Optionally, the relationship establishing module includes:

an address range determining unit, configured to determine, according to the data volume region information, an address range of the volume to be operated;

a stripe relationship establishing unit, configured to establish the stripe mapping relationship between the address range of the volume to be operated and the RAID stripe;

a controller relationship establishing unit, configured to establish the controller correspondence relationship between the address range of the volume to be operated and the target controller.

Optionally, the relationship lookup module includes:

a stripe matching unit, configured to, when receiving the IO processing request, match the target volume of the IO processing request according to the stripe mapping relationship to obtain the RAID stripe;

a controller matching unit, configured to match the target volume of the 10 processing request according to the controller correspondence relationship to obtain the controller.

The present application also provides a RAID system, including:

a processor, configured to establish, according to data volume region information, a stripe mapping relationship between a volume to be operated and a RAID stripe, and a controller correspondence relationship between the volume to be operated and a target controller, wherein the stripe mapping relationship is a relationship where a RAID stripe uniquely corresponds to one volume to be operated; when receiving an IO processing request, determine a controller and RAID stripe corresponding to a target volume of the IO processing request according to the stripe mapping relationship and the controller correspondence relationship;

the controller, configured to control the RAID stripe so as to process the IO processing request by use of the RAID stripe;

the RAID stripe, configured to process the IO processing request.

The present application also provides a storage server, including:

a memory, configured to store a computer program;

a processor, configured to execute the computer program to implement any steps of the IO processing method as described above.

The present application further provides a computer-readable storage medium, having a computer program stored thereon which, when executed by a processor, implements any steps of the IO processing method as described above.

The IO processing method for a RAID system provided in the present application includes: establishing, according to data volume region information, a stripe mapping relationship between a volume to be operated and a RAID stripe, and a controller correspondence relationship between the volume to be operated and a target controller; when receiving an IO processing request, determining a controller and RAID stripe corresponding to a target volume of the IO processing request according to the stripe mapping relationship and the controller correspondence relationship; processing, by use of the RAID stripe through the controller, the IO processing request.

The stripe mapping relationship between the volume to be operated and the RAID stripe and the controller correspondence relationship between the volume to be operated and the target controller are established, then the only exclusive controller and RAID stripe are determined in response to receiving the IO processing request, and finally, the IO processing request is processed by use of the RAID stripe through the controller. As such, the conditions that controllers and RAID stripes corresponding to other IOs are used and that the controller and RAID stripe corresponding to this IO are used for other IOs are avoided. Therefore, right control between controllers and between RAID stripes is implemented without stripe locks, performance loss is avoided, and the processing speed is improved.

The present application also provides an IO processing apparatus for a RAID system, a storage server, and a computer-readable storage medium, all of which have the aforementioned beneficial effects. Elaborations are omitted herein.

### BRIEF DESCRIPTION OF THE DRAWINGS

In order to describe the technical solutions in embodiments of the present application or the prior art more clearly, the drawings required to be used in descriptions about the embodiments or the prior art will be introduced briefly below. Apparently, the drawings in the description below are only the embodiments of the present application. Those ordinarily skilled in the art may further obtain other drawings according to the provided drawings without creative work.

FIG. 1 is a flowchart of an IO processing method for a RAID system according to an embodiment of the present application;

FIG. 2 is a schematic structural diagram of an IO processing apparatus for a RAID system according to an embodiment of the present application.

### DETAILED DESCRIPTION

A core of the present application is to provide an IO processing method and IO processing apparatus for a RAID system, a storage server, and a computer-readable storage medium. A controller and RAID stripe for each IO processing are determined based on an established stripe mapping relationship and controller correspondence relationship, and thus are prevented from being called by other IOs. In this way, control may be implemented without a stripe lock, thereby avoiding performance loss and improving the processing speed.

In order to make the objective, technical solutions, and advantages of the embodiments of the present application clearer, the technical solutions in the embodiments of the present application will be described clearly and completely below in combination with the drawings in the embodiments of the present application. Based on the embodiments of the present application, all other embodiments obtained by those skilled in the art without creative work shall fall within the protection scope of the present application.

In the prior art, when data is written to a stripe, the stripe is locked first. In this way, an IO falling into the stripe in any manner may be processed only after the stripe is unlocked, thereby ensuring the correctness of data access. However, stripe locks cost resources. When an upper-layer system is under a heavy IO load, stripe locks need to wait for release due to excessive consumption, which further affects the IO processing speed. Therefore, stripe lock becomes one of bottlenecks for the storage performance index. Moreover, stripe locks particularly affect the performance in a multi-controller storage system. This is because stripe locks of multiple controllers need communication between the controllers for confirmation, which further affects the storage performance index.

Therefore, the present application provides an IO processing method for a RAID system. The stripe mapping relationship between the volume to be operated and the RAID stripe and the controller correspondence relationship between the volume to be operated and the target controller are established, then the only exclusive controller and RAID stripe are determined in response to receiving the IO processing request, and finally, the IO processing request is processed by use of the RAID stripe through the controller. As such, the conditions that controllers and RAID stripes corresponding to other IOs are used and that the controller and RAID stripe corresponding to this IO are used for other IOs are avoided. Therefore, right control between controllers and between RAID stripes is implemented without stripe locks, performance loss is avoided, and the processing speed is improved.

The IO processing method for a RAID system in the present application will be described below with an embodiment.

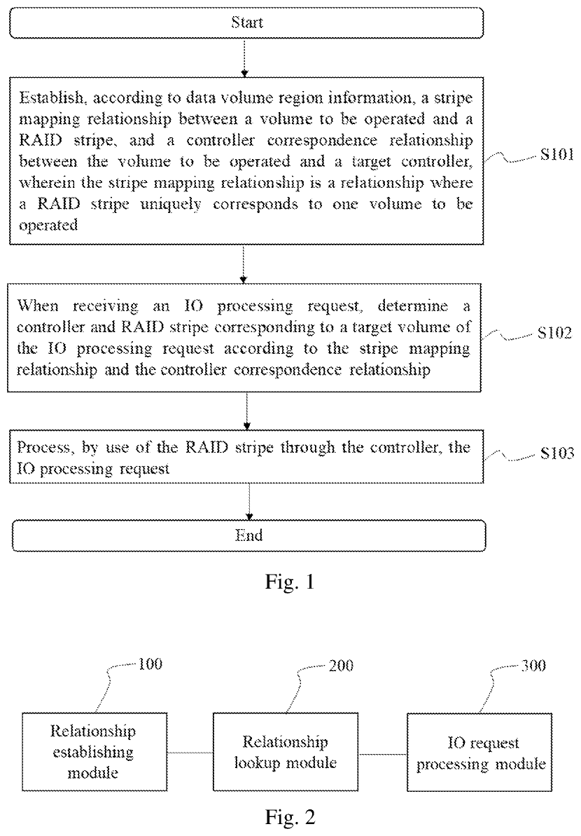

Referring to FIG. 1, FIG. 1 is a flowchart of an IO processing method for a RAID system according to an embodiment of the present application.

In the present embodiment, the method may include the following steps.

S101: establish, according to data volume region information, a stripe mapping relationship between a volume to be operated and a RAID stripe, and a controller correspondence relationship between the volume to be operated and a target controller, wherein the stripe mapping relationship is a relationship where a RAID stripe uniquely corresponds to one volume to be operated.

This step aims to establish a relationship between a volume to be operated and a RAID stripe, and a relationship between the volume to be operated and a controller. That is, a one-to-one correspondence relationship between the volume to be operated and the RAID stripe and a one-to-one correspondence relationship between the volume to be operated and a target controller are established. When an IO processing request of the volume to be operated is transmitted, only the RAID stripe involved in the connection relationship is called, and only the controller involved in the connection relationship is called. That is, based on the established correspondences, only a corresponding RAID stripe and controller are controlled for each IO processing request.

While in the prior art, operations of volumes are not in one-to-one correspondence with RAID stripes, so corresponding RAID stripes are randomly extracted during processing. Moreover, to prevent the RAID stripes from being used for other controllers, stripe locks are used additionally. Using stripe locks in a service system may not only increase the performance loss but also reduce the processing efficiency.

Therefore, in the present embodiment, to avoid mixed use of stripes and controllers, one-to-one correspondences relationship between volumes and stripes and between volumes and controllers are established. As such, mixed use is avoided, namely locking with stripe locks is avoided.

Specifically, the stripe mapping relationship established in this step is a relationship where a RAID stripe uniquely corresponds to one volume to be operated, so it is ensured that a RAID stripe corresponds to only one volume to be operated. That is, each RAID stripe uniquely corresponds to one volume to be operated and is unavailable for other volumes to be operated, thereby ensuring the uniqueness of the RAID stripe. Since volumes to be operated are different in size, a volume may correspond to one or more RAID stripes. No specific limits are made herein. Further, the controller correspondence relationship in the present embodiment represents that the volume to be operated is in one-to-one correspondence relationship with the controller. Based on this, a corresponding RAID stripe and target controller may be determined based on the two correspondences during IO processing.

Specifically, the establishment of the stripe mapping relationship and controller correspondence relationship in the present embodiment may be implemented by a correspondence establishment method provided in the prior art. No specific limits are made herein.

Optionally, the relationships may also be established in this step by the following method.

Step 1: determine, according to the data volume region information, an address range of the volume to be operated.

Step 2: establish the stripe mapping relationship between the address range of the volume to be operated and the RAID stripe.

Step 3: establish the controller correspondence relationship between the address range of the volume to be operated and the target controller.

It can be seen that, in this optional solution, different corresponding RAID stripes and controllers are determined according to address ranges of volumes to be operated. That is, address ranges define different volumes in the present embodiment.

In addition, to avoid stripe resource waste, a capacity of the volume or a size of the stripe may be adjusted such that the capacity of the volume is in an integral multiple relationship with the size of the RAID stripe.

S102: when receiving an IO processing request, determine a controller and RAID stripe corresponding to a target volume of the IO processing request according to the stripe mapping relationship and the controller correspondence relationship.

Based on S101, this step aims to, in response to receiving an IO processing request, determine a controller and RAID stripe corresponding to the IO processing request. Each controller and each RAID stripe uniquely correspond to one volume. Therefore, when an IO processing request of the volume is transmitted, the only controller and RAID stripe may be determined to process the IO processing request. Meanwhile, the controller and RAID stripe corresponding to the volume are not used for IO processing requests of other volumes. As such, the condition that the same controller or RAID stripe is used for different IO processing requests is avoided. That is, mixed use is avoided, and use of stripe locks for operation in the prior art is avoided, thereby avoiding excess performance loss.

Optionally, this step may include:

when receiving the IO processing request, matching the target volume of the 10 processing request according to the stripe mapping relationship to obtain the RAID stripe;

matching the target volume of the IO processing request according to the controller correspondence relationship to obtain the controller.

It can be seen that, in this optional solution, different matching operations are mainly performed on the IO processing request to obtain the corresponding RAID stripe and controller.

S103: process, by use of the RAID stripe through the controller, the IO processing request.

Based on S102, this step aims to process the IO processing request by use of the RAID stripe through the controller. Any processing method provided in the prior art may be selected. No specific limits are made herein.

Optionally, this step may include:

performing a splitting process on the IO processing request by use of the RAID stripe through the controller to obtain multiple IO processing sub-requests;

processing a storage device by use of the multiple IO processing sub-requests.

In summary, according to the present embodiment, the stripe mapping relationship between the volume to be operated and the RAID stripe and the controller correspondence relationship between the volume to be operated and the target controller are established, then the only exclusive controller and RAID stripe are determined in response to receiving the IO processing request, and finally, the IO processing request is processed by use of the RAID stripe through the controller. As such, the conditions that controllers and RAID stripes corresponding to other IOs are used and that the controller and RAID stripe corresponding to this 10 are used for other IOs are avoided. Therefore, right control between controllers and between RAID stripes is implemented without stripe locks, performance loss is avoided, and the processing speed is improved.

The IO processing method for a RAID system in the present application will further be described below with another specific embodiment.

In the present embodiment, the method may include the following steps.

Step 1: establish, according to data volume range information, a stripe mapping relationship between a volume to be operated and a RAID stripe, and a controller correspondence relationship between the volume to be operated and a target controller.

Step 2: when receiving an IO processing request, determine a controller and RAID stripe corresponding to a target volume of the IO processing request according to the stripe mapping relationship and the controller correspondence relationship.

Step 3: process, by use of the RAID stripe through the controller, the IO processing request.

A main objective of the present embodiment is to eliminate RAID stripe locks. Eliminating RAID stripe locks may improve the performance. This is mainly because lock is a finite resource, and when upper-layer services are highly concurrent, lock may restrict the further improvement of the performance as a common resource. This is also because stripe locking needs multiple communications. Specifically, stripe locking between multiple controllers is completed in a manner that a controller sends a locking request to an opposite controller, and the opposite controller, after locking, sends confirmation information to the local controller. Such a handshake communication mechanism also affects the performance to some extents. The RAID stripe lock is for ensuring the correctness of data access and preventing data chaos caused by simultaneous access of multiple threads or services to the same stripe.

Specifically, in the present embodiment, mapping relationships between volumes and RAID stripes are controlled to ensure that any RAID stripe corresponds to only one volume, and volumes are in one-to-one correspondence with controllers, namely each volume corresponds to one controller. When an upper-layer service transmits an IO, each volume may transmit the IO through only one controller, and in addition, a RAID stripe corresponds to only one volume, so concurrent processing of a single stripe between multiple controllers may be avoided. Therefore, the effect of a stripe lock is achieved, the RAID performance is optimized, and furthermore, the performance index of a storage system is improved.

It can be seen that, according to the present embodiment, the stripe mapping relationship between the volume to be operated and the RAID stripe and the controller correspondence relationship between the volume to be operated and the target controller are established, then the only exclusive controller and RAID stripe are determined in response to receiving the IO processing request, and finally, the IO processing request is processed by use of the RAID stripe through the controller. As such, the conditions that controllers and RAID stripes corresponding to other IOs are used and that the controller and RAID stripe corresponding to this IO are used for other IOs are avoided. Therefore, right control between controllers and between RAID stripes is implemented without stripe locks, performance loss is avoided, and the processing speed is improved.

An IO processing apparatus for a RAID system in the embodiments of the present application will be introduced below. The IO processing apparatus for a RAID system described below may make corresponding references mutually with the IO processing method for a RAID system described above.

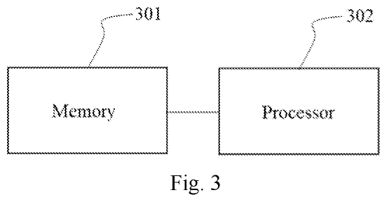

Referring to FIG. 2, FIG. 2 is a schematic structural diagram of an IO processing apparatus for a RAID system according to an embodiment of the present application.

In the present embodiment, the apparatus may include:

a relationship establishing module 100, configured to establish, according to data volume region information, a stripe mapping relationship between a volume to be operated and a RAID stripe, and a controller correspondence relationship between the volume to be operated and a target controller, wherein the stripe mapping relationship is a relationship where a RAID stripe uniquely corresponds to one volume to be operated;

a relationship lookup module 200, configured to, when receiving an IO processing request, determine a controller and RAID stripe corresponding to a target volume of the IO processing request according to the stripe mapping relationship and the controller correspondence relationship;

an IO request processing module 300, configured to process, by use of the RAID stripe through the controller, the IO processing request.

Optionally, the relationship establishing module 100 may include:

an address range determining unit, configured to determine, according to the data volume region information, an address range of the volume to be operated;

a stripe relationship establishing unit, configured to establish the stripe mapping relationship between the address range of the volume to be operated and the RAID stripe;

a controller relationship establishing unit, configured to establish the controller correspondence relationship between the address range of the volume to be operated and the target controller.

Optionally, the relationship lookup module 200 may include:

a stripe matching unit, configured to, when receiving the IO processing request, match the target volume of the IO processing request according to the stripe mapping relationship to obtain the RAID stripe;

a controller matching unit, configured to match the target volume of the IO processing request according to the controller correspondence relationship to obtain the controller.

The embodiments of the present application also provide a storage server, including:

a memory, configured to store a computer program;

a processor, configured to execute the computer program to implement the steps of the IO processing method as described in the above embodiment.

The embodiments of the present application further provide a computer-readable storage medium, having a computer program stored thereon which, when executed by a processor, implements any steps of the IO processing method as described in the above embodiments.

The computer-readable storage medium may include various media capable of storing program codes, such as a U disk, a mobile hard disk, a Read-Only Memory (ROM), a Random Access Memory (RAM), a magnetic disk, or an optical disk.

The embodiments of the present application also provide a RAID system, including:

a processor, configured to establish, according to data volume region information, a stripe mapping relationship between a volume to be operated and a RAID stripe, and a controller correspondence relationship between the volume to be operated and a target controller, wherein the stripe mapping relationship is a relationship where a RAID stripe uniquely corresponds to one volume to be operated; when receiving an IO processing request, determine a controller and RAID stripe corresponding to a target volume of the IO processing request according to the stripe mapping relationship and the controller correspondence relationship;

the controller, configured to control the RAID stripe so as to process the IO processing request by use of the RAID stripe;

the RAID stripe, configured to process the IO processing request.

All the embodiments in this specification are described in a progressive manner. Contents mainly described in each embodiment are different from those described in other embodiments. Same or similar parts of all the embodiments refer to each other. For the apparatus disclosed in the embodiments, since it corresponds to the method disclosed in the embodiments, the description is relatively simple, and the relevant part can be referred to the description of the method part.

The skilled person may further realize that the units and algorithmic steps of each example described in conjunction with the embodiments disclosed herein are capable of being implemented in electronic hardware, computer software, or a combination of both, and that the composition and steps of each example have been described generally by function in the above description for the purpose of clearly illustrating the interchangeability of hardware and software. Whether these functions are performed in hardware or software depends on the particular application and design constraints of the technical solution. The skilled person may use different methods to implement the described functions for each particular application, but such implementation should not be considered as going beyond the scope of the present application.

The steps of a method or algorithm described in conjunction with the embodiments disclosed herein may be directly implemented in hardware, a software module executed by a processor, or a combination of the hardware and the software module. The software module can be placed in a random access memory (RAM), an internal memory, a read only memory (ROM), an electrically programmable ROM, an electrically erasable programmable ROM, a register, a hard disk, a mobile disk, a CD-ROM, or any storage medium in other forms known to the technical field.

The IO processing method and IO processing apparatus for a RAID system, storage server, and computer-readable storage medium provided in the present application are introduced above in detail. Specific examples are applied in this specification to illustrate the principle and embodiments of the present application, and the above description of the embodiments is only used to help understand the method of the present application and the core idea thereof. It should be noted that for a person of ordinary skill in the art, several improvements and modifications can be made to the present application without departing from the principle of the present application, and these improvements and modifications also fall within the scope of protection of the claims of the present application.

1. An Input/Output (IO) processing method for a Redundant Array of Independent Disks (RAID) system, comprising:
establishing, according to data volume region information, a stripe mapping relationship between a volume to be operated and a RAID stripe, and a controller correspondence relationship between the volume to be operated and a target controller, wherein the stripe mapping relationship is a relationship where the RAID stripe uniquely corresponds to one volume to be operated;
in response to receiving an IO processing request, determining a controller and RAID stripe corresponding to a target volume of the IO processing request according to the stripe mapping relationship and the controller correspondence relationship; and
processing, by use of the RAID stripe through the controller, the IO processing request.

2. The IO processing method according to claim 1, wherein the establishing, according to data volume region information, a stripe mapping relationship between a volume to be operated and a RAID stripe, and a controller correspondence relationship between the volume to be operated and a target controller comprises:
determining, according to the data volume region information, an address range of the volume to be operated;
establishing the stripe mapping relationship between the address range of the volume to be operated and the RAID stripe; and
establishing the controller correspondence relationship between the address range of the volume to be operated and the target controller.

3. The IO processing method according to claim 1, wherein the in response to receiving an IO processing request, determining a controller and RAID stripe corresponding to a target volume of the IO processing request according to the stripe mapping relationship and the controller correspondence relationship comprises:
in response to receiving the IO processing request, matching the target volume of the IO processing request according to the stripe mapping relationship to obtain the RAID stripe; and
matching the target volume of the IO processing request according to the controller correspondence relationship to obtain the controller.

4. The IO processing method according to claim 1, wherein a capacity of the volume to be operated is in an integral multiple relationship with a size of the RAID stripe.

5. The IO processing method according to claim 1, wherein the processing, by use of the RAID stripe through the controller, the IO processing request comprises:
performing a splitting process on the IO processing request by use of the RAID stripe through the controller to obtain multiple IO processing sub-requests; and
processing a storage device by use of the multiple IO processing sub-requests.

6.-8. (canceled)

9. A storage server, by comprising:
a memory, configured to store a computer program; and
a processor, configured to execute the computer program to implement any steps of an Input/Output (IO) processing method, wherein the IO processing method comprises:
establishing, according to data volume region information, a stripe mapping relationship between a volume to be operated and a Redundant Array of Independent Disks (RAID) stripe, and a controller correspondence relationship between the volume to be operated and a target controller, wherein the stripe mapping relationship is a relationship where the RAID stripe uniquely corresponds to one volume to be operated;
in response to receiving an IO processing request, determining a controller and RAID stripe corresponding to a target volume of the IO processing request according to the stripe mapping relationship and the controller correspondence relationship; and
processing, by use of the RAID stripe through the controller, the IO processing request.

10. A computer-readable storage medium, having a computer program stored thereon which, when executed by a processor, implements any steps of an Input/Output (IO) processing method, wherein the IO processing method comprises:
establishing, according to data volume region information, a stripe mapping relationship between a volume to be operated and a Redundant Array of Independent Disks (RAID) stripe, and a controller correspondence relationship between the volume to be operated and a target controller, wherein the stripe mapping relationship is a relationship where the RAID stripe uniquely corresponds to one volume to be operated;
in response to receiving an IO processing request, determining a controller and RAID stripe corresponding to a target volume of the IO processing request according to the stripe mapping relationship and the controller correspondence relationship; and
processing, by use of the RAID stripe through the controller, the IO processing request.

11. The IO processing method according to claim 1, wherein each RAID stripe uniquely corresponds to one volume to be operated and is unavailable for other volumes to be operated.

12. The IO processing method according to claim 1, wherein a volume corresponds to one or more RAID stripes.

13. The storage server according to claim 9, wherein the establishing, according to data volume region information, a stripe mapping relationship between a volume to be operated and a RAID stripe, and a controller correspondence relationship between the volume to be operated and a target controller comprises:
determining, according to the data volume region information, an address range of the volume to be operated;
establishing the stripe mapping relationship between the address range of the volume to be operated and the RAID stripe; and
establishing the controller correspondence relationship between the address range of the volume to be operated and the target controller.

14. The storage server according to claim 9, wherein the in response to receiving an processing request, determining a controller and RAID stripe corresponding to a target volume of the IO processing request according to the stripe mapping relationship and the controller correspondence relationship comprises:
in response to receiving the IO processing request, matching the target volume of the IO processing request according to the stripe mapping relationship to obtain the RAID stripe; and
matching the target volume of the IO processing request according to the controller correspondence relationship to obtain the controller.

15. The storage server according to claim 9, wherein a capacity of the volume to be operated is in an integral multiple relationship with a size of the RAID stripe.

16. The storage server according to claim 9, wherein the processing, by use of the RAID stripe through the controller, the IO processing request comprises:
performing a splitting process on the IO processing request by use of the RAID stripe through the controller to obtain multiple IO processing sub-requests; and
processing a storage device by use of the multiple IO processing sub-requests.

17. The storage server according to claim 9, wherein each RAID stripe uniquely corresponds to one volume to be operated and is unavailable for other volumes to be operated.

18. The storage server according to claim 9, wherein a volume corresponds to one or more RAID stripes.

19. The computer-readable storage medium according to claim 10, wherein the establishing, according to data volume region information, a stripe mapping relationship between a volume to be operated and a RAID stripe, and a controller correspondence relationship between the volume to be operated and a target controller comprises:
determining, according to the data volume region information, an address range of the volume to be operated;
establishing the stripe mapping relationship between the address range of the volume to be operated and the RAID stripe; and
establishing the controller correspondence relationship between the address range of the volume to be operated and the target controller.

20. The computer-readable storage medium according to claim 10, wherein the in response to receiving an IO processing request, determining a controller and RAID stripe corresponding to a target volume of the IO processing request according to the stripe mapping relationship and the controller correspondence relationship comprises:
in response to receiving the IO processing request, matching the target volume of the 10 processing request according to the stripe mapping relationship to obtain the RAID stripe; and
matching the target volume of the IO processing request according to the controller correspondence relationship to obtain the controller.

21. The computer-readable storage medium according to claim 10, wherein a capacity of the volume to be operated is in an integral multiple relationship with a size of the RAID stripe.

22. The computer-readable storage medium according to claim 10, wherein the processing, by use of the RAID stripe through the controller, the IO processing request comprises:
performing a splitting process on the IO processing request by use of the RAID stripe through the controller to obtain multiple IO processing sub-requests; and
processing a storage device by use of the multiple IO processing sub-requests.

23. The computer-readable storage medium according to claim 10, wherein each RAID stripe uniquely corresponds to one volume to be operated and is unavailable for other volumes to be operated.
